(19) United States
(12) Patent Application Publication
(10) Pub. No.: US 2015/0185131 A1
(43) Pub. Date: Jul. 2, 2015

(54) METHOD AND DEVICE FOR MEASURING THE LIQUID VISCOSITY

(71) Applicant: NATIONAL CHENG KUNG UNIVERSITY, TAINAN CITY (TW)

(72) Inventors: HAN-SHENG CHUANG, TAINAN CITY (TW); YUE-SYUN SIE, TAINAN CITY (TW)

(73) Assignee: NATIONAL CHENG KUNG UNIVERSITY, TAINAN CITY (TW)

(21) Appl. No.: 14/140,701

(22) Filed: Dec. 26, 2013

(51) Int. Cl. G01N 11/00; G01B 11/14; G01N 15/10

(52) U.S. Cl. CPC G01N 11/00; G01N 15/10; G01B 11/14; G01N 2011/008

(57) ABSTRACT

The present invention relates to a method and a device for measuring liquid viscosity based on Brownian movements of particles suspended in a fluid.

### BACKGROUND OF THE INVENTION

1. Field of the Invention

The present invention relates to a method and a device for measuring liquid viscosity based on Brownian movements of particles suspended in a fluid.

2. Description of Related Art

Viscosity is one of the vital characteristics of a liquid for change of flow resistances and flow fields. Up to now, there are many conventional instruments for measuring liquid viscosity as followings. Taiwan Patent No. 405040, issued on 11 Sep. 2000, disclosed a transducer for a vibratory viscometer including a hollow cylindrical sheath and a hollow cylindrical shaft disposed within the hollow cylindrical sheath. The hollow cylindrical shaft has a first end and a second end connected to a distal end of the hollow cylindrical sheath. The viscometer includes a sensor tip connected to the distal end of the hollow cylindrical sheath. The sensor tip has an inner surface defining a hollow region and a support tube disposed within the hollow region for holding a temperature sensor. The viscometer further includes a crossbar coupled to the first end of the hollow cylindrical shaft. Also, Taiwan Patent No. 1352806, issued on 21 Nov. 2011, disclosed a method for measuring viscosity by a falling sphere viscometer, including the steps of: preparing a cylindrical tube, filling a liquid sample to be measured into the cylindrical tube, placing a falling sphere in the liquid sample, recording the time required for the sphere falling in a specific distance through the liquid sample, offering the diameter and density of the falling sphere and the density of the liquid sample, and at last obtaining viscosity of the liquid sample based on an iterative method.

However, the foregoing apparatuses or methods for measuring viscosity require more than 10 μL sample volume. In such a case, if the sample is expensive or rare, the conventional apparatuses or methods fail operate. Furthermore, the measuring units for the conventional apparatuses or methods must be added into the sample. The sample will be prone to get contaminated based on such invasive measurements and thus the results of measurement will be affected undesirably. The conventional apparatuses or methods are usually costly so that it is not easy for researchers to access to them.

### SUMMARY OF THE INVENTION

In view of the above-mentioned problems, the object of the present invention is to provide a method and a device for measuring liquid viscosity based on Brownian movements of particles suspended in a fluid.

Disclosed herein are a device and methods for calculating and measuring viscosity of a liquid.

A method for calculating viscosity of a liquid, comprising the steps of: preparing a liquid; adding a particle into the liquid in which the particle generates a Brownian motion; capturing a plurality of particle images within a unit time; obtaining a displacement from the particle images; and calculating viscosity of the liquid from the displacement.

A method for measuring viscosity of a liquid comprises the steps of: preparing a liquid having a particle; recording a displacement generated from a Brownian motion caused by the particle in the liquid within a unit time; and measuring the liquid viscosity from the displacement.

A device for measuring viscosity of a liquid comprises: a loading unit for loading a liquid having a particle; and a measuring unit for measuring a displacement generated from a Brownian motion caused by the particle in the liquid within a unit time, and measuring the liquid viscosity from the displacement.

### BRIEF DESCRIPTION OF THE DRAWINGS

FIG. 1 is a flowchart for measuring viscosity of a liquid;

FIG. 2 is a schematic diagram of the device for measuring viscosity of a liquid;

FIG. 3A is a particle image obtained from the device;

FIG. 3B is an intensity correlation peak derived from the particle image;

FIG. 4 is a conventional viscosity table of glycerol;

FIG. 5A is a diagram showing the viscosity of the water;

FIG. 5B is a comparison of viscosities between water and different glycerol solutions;

FIG. 5C is a data showing the viscosity of the different glycerol solutions measured by a conventional viscosity table and the present invention;

FIG. 5D is a calibration curve derived from the correction factors (k) at three viscosity values;

FIG. 6A is a diagram showing the relationship between the peak width and the time interval for different concentrations of the dextran solutions;

FIG. 6B is a data showing the viscosity of the different dextran solutions measured by a conventional viscometer and the present invention;

FIG. 7 is a schematic diagram showing the device of an embodiment for measuring viscosity of a liquid.

### DETAILED DESCRIPTION OF THE PREFERRED EMBODIMENT

Hereinafter, an exemplary embodiment of the present invention will be described in detail with reference to the accompanying drawings.

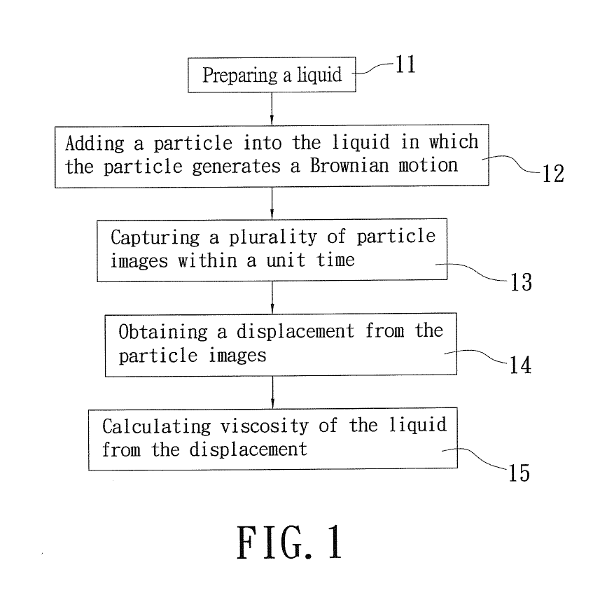

First, referring to FIG. 1, a flowchart for measuring viscosity of a liquid is disclosed, comprising as followings:

Step 1 (11): preparing a liquid;

Step 2 (12): adding a particle into the liquid in which the particle generates a Brownian motion (a random moving of particles suspended in a liquid resulting from temperature and their unbalanced particles interactions);

Step 3 (13): capturing a plurality of particle images within a unit time;

Step 4 (14): obtaining a displacement from the particle images; and

Step 5 (15): calculating viscosity of the liquid from the displacement.

It is worth mentioning that the method of the present invention doesn't limit the characteristics of the liquid, so it can apply to Newtonian liquid or non-Newtonian liquid as well.

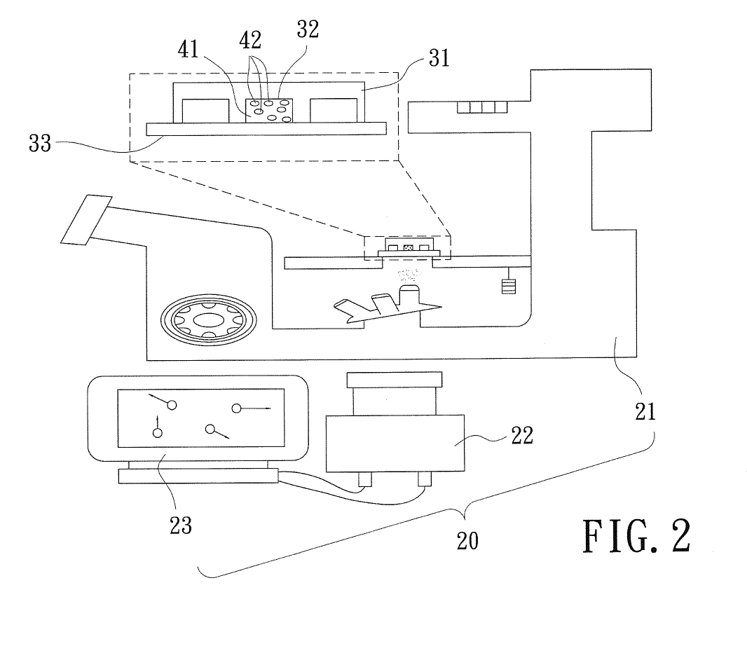

Referring to FIG. 2, a schematic diagram of the device for measuring viscosity of a liquid is disclosed. The device (20) includes an inverted microscope (21), an image capturing apparatus (22) and a calculating apparatus (23). The inverted microscope (21) is used for loading a sample vessel (31) having at least one well (32). The liquid (41) having a plurality of particles (42) is loaded onto the well (32). The particles (42) are neutrally buoyant which generate Brownian motions in the liquid (41). After the liquid (41) containing the particles (42) is added into the well (32), the well (32) is sealed with a cover slip (33) so that excessive liquid (41) is squeezed out of the well (32). Meanwhile, it can keep the liquid (41) containing the particle (42) within a closed system.

Furthermore, when the cover slip (33) is covering on the well (32), there forms a liquid (41) membrane due to the interaction caused by the sample vessel (31), the cover slip (33) and the liquid (41). The liquid (41) membrane may affect the accuracy of the following measurement, so it could be eliminated by exerting an appropriate and uniform force on the cover slip (33).

After the well (32) is added with a liquid (41) having particles (42), then it can be placed at the stage of the inverted microscope (21). The image capturing apparatus (22) captures a plurality of particle (42) images amplified by the inverted microscope (21) within a unit time. Then the particle (42) images are transmitted into the calculating apparatus (23) to obtain a displacement of particles (42) within a unit time from the particle (42) images. Furthermore, viscosity of the liquid (41) is calculated from the displacement. Generally, the increased liquid viscosity results in the fewer displacement of the particle (42) in the liquid (41) within a unit time.

According to the embodiment of the present invention, the device (20) measured the liquid viscosity by means of Particle Image Velocimetry (PIV), wherein the image capturing apparatus (22) is a CCD camera. By using PIV, the displacement generated from the particles (42) flowing toward various directions resulted in the shift of the image intensity correlation peak. The increased liquid viscosity results in the fewer shifted radius of the image intensity correlation peak.

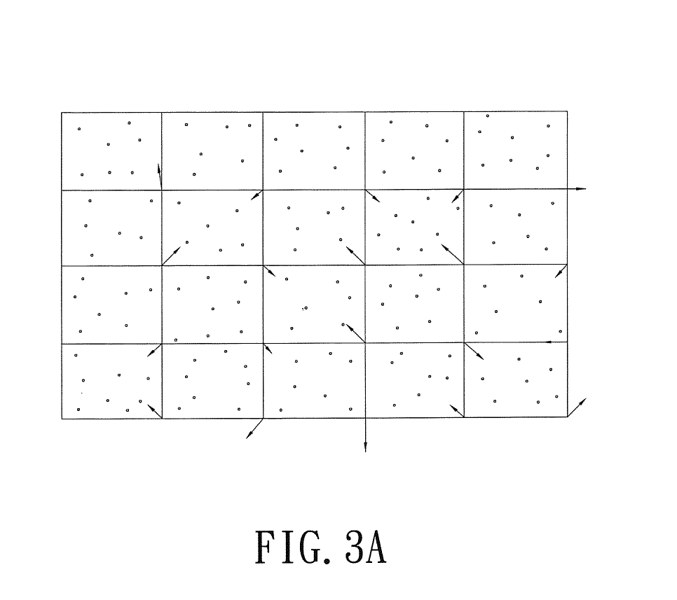

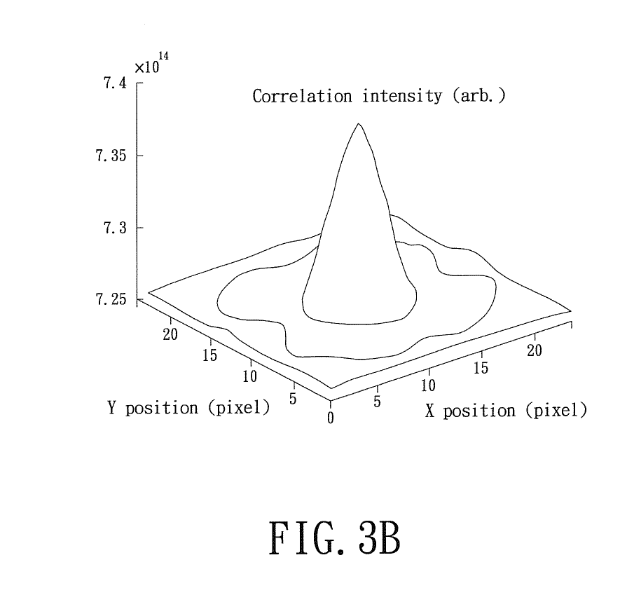

Referring to FIG. 3A, a particle image obtained from the device as shown in FIG. 2 is disclosed. The particle image is divided into many interrogation windows. There are a plurality of particles (as “dots” shown in FIG. 3A) on each interrogation window. After recording the displacement generated from Brownian motions caused by the particles in the liquid within a unit time, each interrogation window acquires the results (as “arrows” shown in FIG. 3A) from the displacement. The direction and the length of each arrow represent the summation of overall displacement directions and distances of particles respectively. Because the results of displacements are primarily resulted from Brownian motions, the summations of the displacements are thus represented with various directions and distances.

It is worth mentioning that the number and the shape (such as rectangle or non-rectangle) of the divided interrogation windows on each particle image can be changed depending on users' demands.

After the results as shown in FIG. 3A are superimposed and analyzed by cross correlation algorithm, image intensity correlation peak can be acquired as shown in FIG. 3B. It is known that the increased liquid viscosity results in the fewer shifted radius of the image intensity correlation peak. An embodiment of the present invention comprises an operating instruction as followings. To prepare a mixed liquid, the particles (1 μm in diameter) are homogenously dispersed in a liquid in 1:50 (v/v). Then the mixed liquid is added into the well of the sample vessel made of polydimethylsiloxane (PDMS, Sylgar 184, Ellsworth Adhesives). Each well (2 mm in diameter and 40.2 μm in depth) is sealed with a cover slip to reduce disturbances from the ambient environment.

Then the displacement from the particle image of the mixed liquid is analyzed with Evaluation software for Digital Particle Image Velocimetry (EDPIV). The interrogation window size of 96×96 pixels, and grid size of 48×48 pixels are chosen. Furthermore, it must set the filter condition (mipv, and 1/pix=46082) according to CCD camera arranged in pair of the inverted microscope (1 pix=21.7 μm) and finally adjust the time interval between two consecutive images. In the embodiment, the acquired image size is 624×432 pixels, resulting in 117 interrogation windows (each containing ensemble of image intensity change of 24×24 images), and the acquired image is analyzed by auto-correlation. Then all the interrogation windows originating from a pair of images are summed up in the correlation domain (i.e., ensemble average). Although a pair of images is adequate for the viscosity analysis, five pairs of images are actually taken for each datum to reduce errors. The summation will then form an ensemble averaged correlation peak. By the means of Matlab software, a two-dimensional Gaussian curve fit (order ‘cftool’) is used to delineate the intensity profile. Two peak widths ((ΔSₐ)ₓ and (ΔSₐ)_{y}) and the average (ΔSₐ) thereof can be acquired by the fitting function a₁e^{-(x-b1/C1)}^{²} (c1=width). In addition, by a) cross-correlation analysis (with the same time interval between two images as description of auto-correlation analysis), an average (ΔS_{c}) of two peaks widths can be acquired. By using PIV measuring Brownian motions, it can learn that there is a relationship within the viscosity, width, and the environmental parameter. When applying for the present embodiment, the relationship can be illustrated as following.

$${μ}_{calculate} = {β}_{‖} \frac{16 {k}_{B} {M}^{2}}{3 π dp} T \frac{Δ t}{( Δ {S}_{C}^{2} - Δ {S}_{a}^{2} )} \qquad Formula 1$$

β_{∥} is a correction error of particle in parallel direction.

$${β}_{‖} = 1 - \frac{9}{16} ( \frac{a}{z} ) + \frac{1}{8} {( \frac{a}{z} )}^{3} \qquad Formula 2$$

From formulas 1 and 2, the equation can be elicited as following:

$${μ}_{calculate} = [ 1 - \frac{9}{16} ( \frac{a}{z} ) + \frac{1}{8} {( \frac{a}{z} )}^{3} ] \frac{16 {k}_{B} {M}^{2}}{3 π {d}_{p}} T \frac{Δ t}{( Δ {S}_{C}^{2} - Δ {S}_{a}^{2} )} \qquad Formula 3$$

a diameter of the particle (dₚ)=1 μm;
a radius of the particle (a)=0.5 μm;
a half depth of the well (z)=20.1 μm;
Boltzmann constant (k_{B})=1.38065×10⁻²³ pa·m³;
magnification of the imaging system (M)=64;
absolute temperature of the liquid (T)=23° C.; and
time interval between two consecutive images (Δt).

In particular, a thermocouple is placed adjacent to the inverted microscope to monitor the temperature variation in case of interfering with Brownian motions in the liquid.

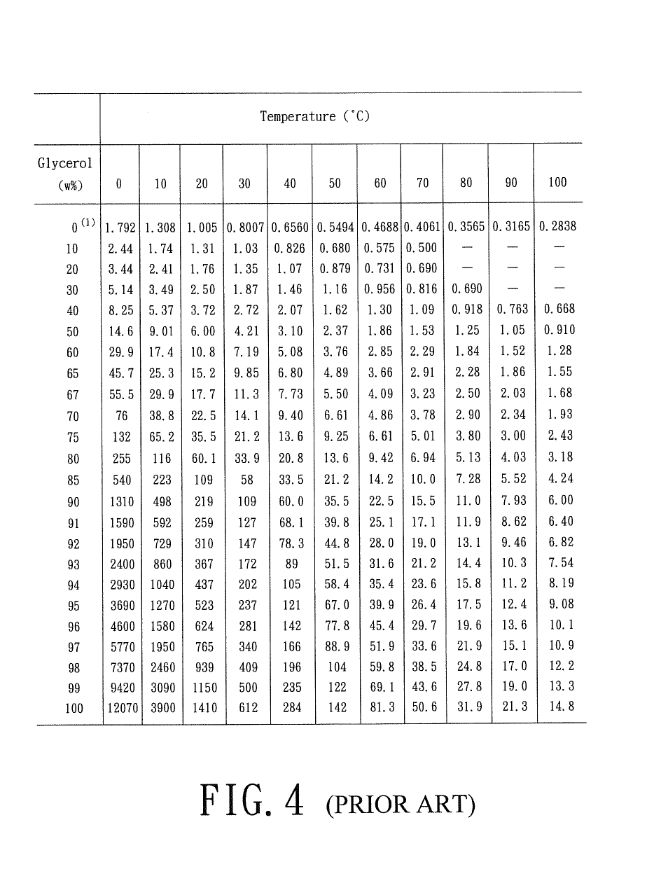

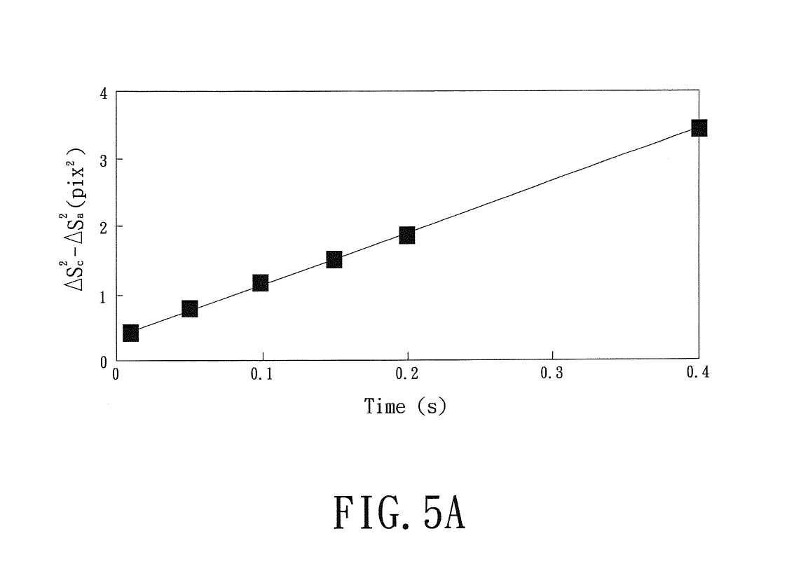

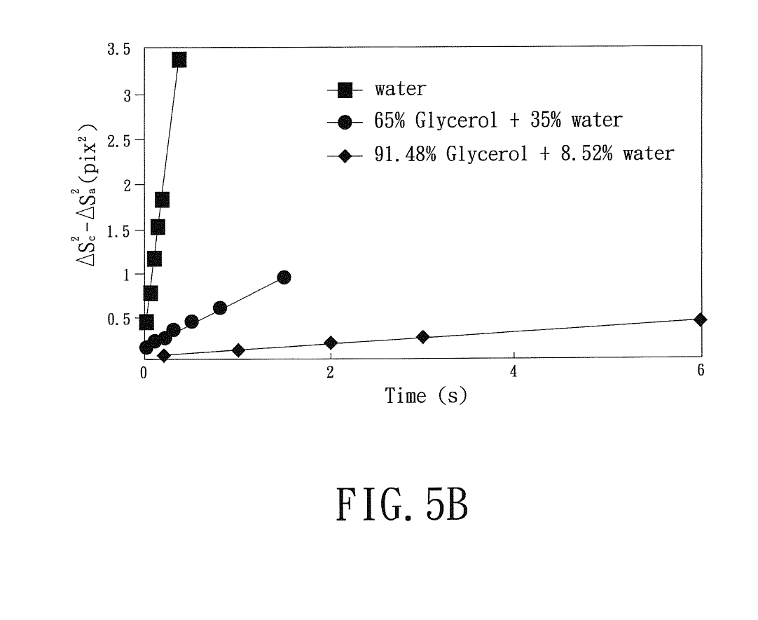

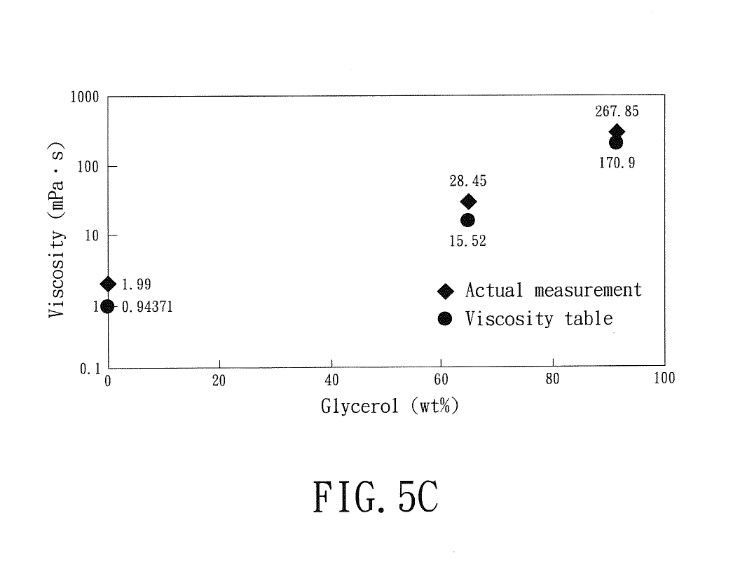

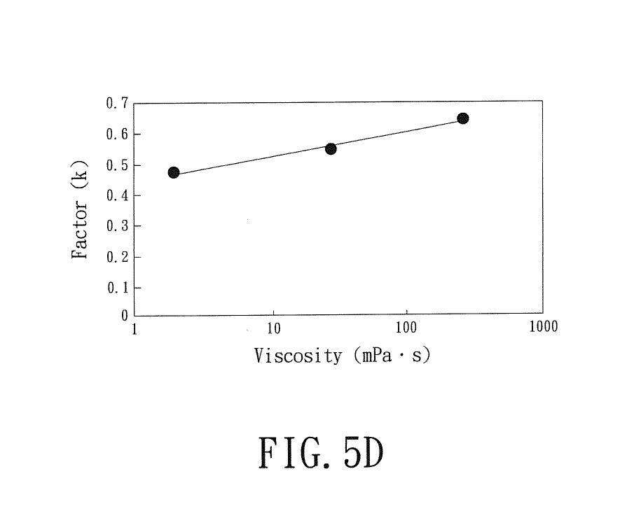

If the aforementioned parameter and the ratio of Δt/(ΔS_{C}²−ΔSₐ²) are known, then the actual viscosity of the liquid can be acquired. Furthermore, for simplicity, glycerol solutions are used as references for the comparison. 0% (water), 65%, and 91.48% glycerol solutions are prepared for measuring viscosity thereof by the device. According to the conventional viscosity table of glycerol as shown in FIG. 4, the viscosities of 0%, 65%, and 91.48% glycerol solutions can be acquired of 0.94371, 15.52, and 170.90 mPa·s, respectively, by using interpolation method. Referring to FIG. 5A, a diagram showing the viscosity of the water, wherein the slope of the water is (ΔS_{C}²−ΔSₐ²)/Δt=7.48 (regression curve is y=7.48x+0.3879). FIG. 5B is a comparison of viscosities between water and different glycerol solutions. The data show that the peak width progressively increases with the time interval. A linear curve fit is also used to estimate the slope for a viscosity calculation. The regression curve of 0%, 65%, and 91.48% glycerol solutions are y=7.48x+0.3879, y=0.5264x+0.1694 and y=0.0564x+0.3879, respectively, and the slope of 0%, 65%, and 91.48% glycerol solutions are 7.48, 0.5264 and 0.0564, respectively. Obviously, there is an inverse relationship between the viscosity and the slope of the sample.

After the slope values (7.48, 0.5264 and 0.0564) of the different glycerol solutions are determinate, the values 1.99, 28.45 and 267.85 mPa·s as shown in FIG. 5C can be acquired from the equation of Formula 3. Furthermore, 0.94371, 15.52, and 170.90 divided by 1.99, 28.45 and 267.85, respectively to get the values thereof. Thus a correction function y=3.31474E-021n(x)+4.46341E-01 (R²=9.84441E-01) can be obtained from these values and the results are shown in FIG. 5D. That is to say, if the values obtained from the present device and the method thereof are measured at about 23□, then the values can be similar to the actual values of viscosity after correction function conversion. In practice, the correction function can be varied according to the change of the values corresponding to the temperature shown in FIG. 4, and thus a new correction function can be acquired by means of the present device and the method thereof.

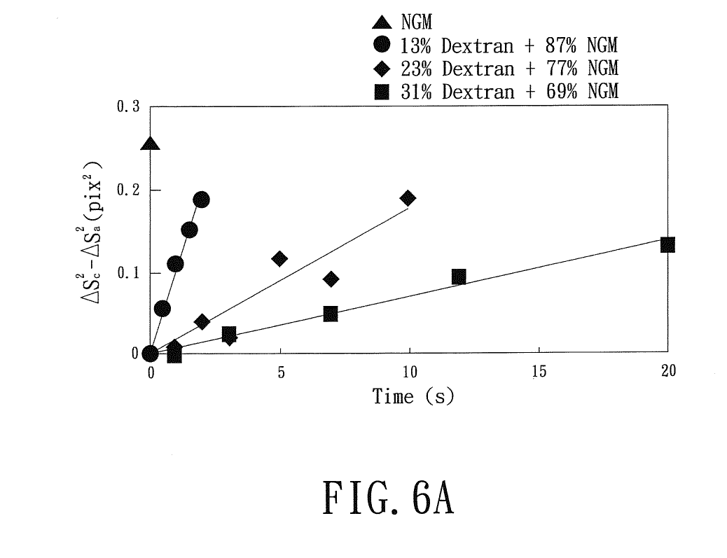

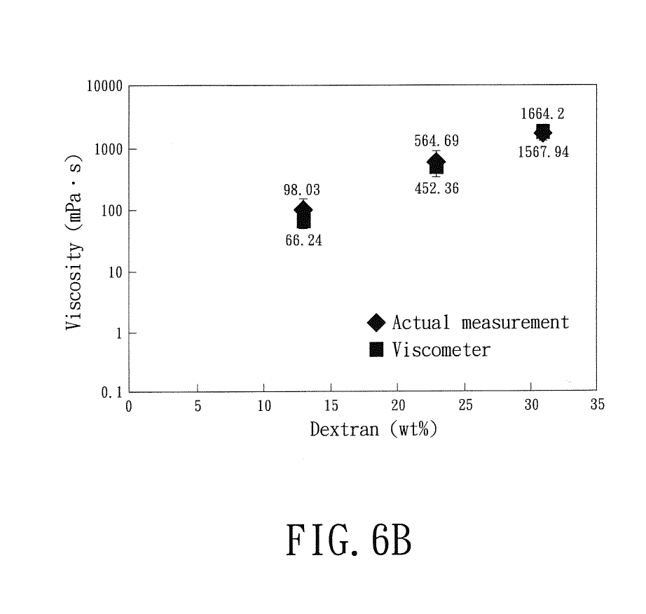

Referring to FIG. 6A, is a diagram showing the relationship between the peak width and the time interval for different concentrations of the dextran solutions. In an effort to create a broad range of viscosity, different weight ratios (w/w) of dextran (13%, 23% and 31%) were dissolved in a nematode growth medium (NGM) buffer at about 23□. The viscosities of three dextran solutions are measured by the present device and the method thereof. It can learned that when the weight ratio of dextran are increased from 0% to 13%, 23% and 31%, the values of the slopes ((ΔS_{C}²−ΔSₐ²)/Δt) are decreased gradually.

The viscosities of synthesized solutions ranges from 1.23±0.21 to 1664.2±380.44 mPa·s corresponding to the dextran solutions from 0 to 31%, respectively. After applying the aforementioned values of the slopes to the correction function y=3.31474E-021n(x)+4.46341E-01, the values of 98.03, 564.69 and 1664.2 mPa·s respectively representing 13%, 23% and 31% dextran solutions can be acquired. Besides, the same dextran solutions are also measured with a commercial torque viscometer (DVE, Brookfield) and thus gets the three values of viscosities 66.24, 452.36 and 1567.94. As shown in FIG. 6B, the comparison shows that our data are comparable to the data from the commercial viscometer. The result confirms that the small-volume and broad-range measurability of the present invention does not weaken the reliability of the technique for measuring the viscosity. Furthermore, the present invention can still acquire the viscosity precisely even though it is excess than 1000 mPa·s.

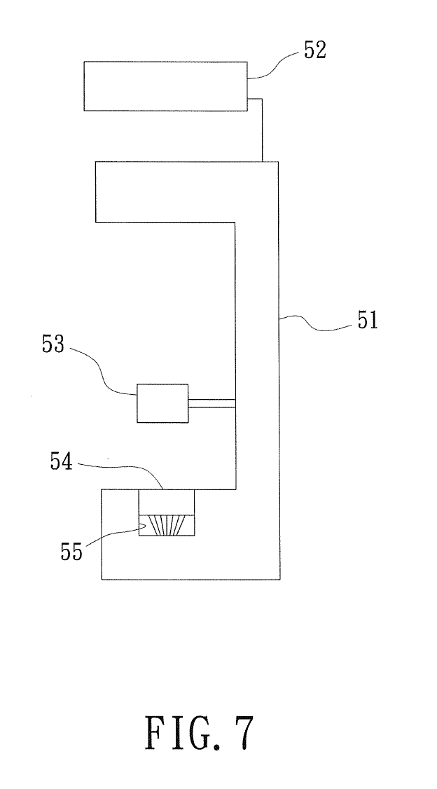

Referring to FIG. 7, a schematic diagram showing the device of an embodiment for measuring viscosity of a liquid is disclosed. The device comprises an inverted microscope (51) and an image capture device (52). Moreover, a filter (53) can be disposed depending on users' demand. The device as shown in FIG. 7, is mainly used to load a chip (54) having one or more well (55) therein for accommodating the liquid sample. According to the device as shown in FIG. 7, the present invention can achieve the commercialized aims at convenience and low-cost by the simple components therein and supplement with disposable chip (such as chip (54)). The filter (53) can be selected from the group consisting of solid (lens) type, gas type and liquid type and disposed on the light path between the well (55) and the image capture device (52) to exclude unwanted optical signal for reducing the noise and/or enhancing the signal intensity from particle motion images captured by the image capture device (52). Furthermore, the filter (53) may also designed to be removable, replaceable, and/or stacking depending on different needs or conditions to get the best signal of the particle motion images. The embodiment of the device as shown in FIG. 7 are the same as aforementioned embodiment and method.

The used particles can be hydrophobic or hydrophylic depending on the characteristics of the liquid and with diameters ranging from 0.05 μm to 1 μm. There are 4×10⁷ to 4×10⁹ particles in every volume (mm³) of the liquid (an empirically optimal concentration of 3.74×10⁸ count/mL is used in the measurements). Moreover, the particles can be tagged with fluorescence or luminescence according to the users' demands. In addition, the sample vessel can be the one containing a plurality of wells so that it can load many samples for measuring at one time. Furthermore, the sample can be measured in an open system, such in a well without covering the cover slip.

In the other embodiment of the present invention, the liquid itself contains visible particles, so the step of adding particle into the liquid can be omitted. If these visible particles undergo Brownian motions in the liquid, then the viscosity thereof can be acquired.

According to the embodiments as described above, a device for measuring viscosity of a liquid is provided, comprising a loading unit and a measuring unit. The loading unit is used for loading a liquid having a particle. The measuring unit is used for measuring a displacement generated from a Brownian motion caused by the particle in the liquid within a unit time, and further measuring the liquid viscosity from the displacement.

In the aforementioned embodiments, the measurement of the displacement within a unit time can be acquired not merely by using the PIV or images. It can also be acquired by other methods provided that they don't affect the Brownian motion. Then the viscosity can further be calculated by the recording displacement.

Specifically, the embodiments can offer more detailed descriptions as followings.

1. A method for calculating viscosity of a liquid comprises the steps of: preparing a liquid; adding a particle into the liquid in which the particle generates a Brownian motion; capturing a plurality of particle images within a unit time; obtaining a displacement from the particle images; and calculating viscosity of the liquid from the displacement.

2. As the method described in embodiment 1, wherein the particle at least has a diameter ranging from 0.05 μm to 1 μm, or is suspended in a liquid concentration ranging from 4×10⁷ particles/mm³ to 4×10⁹ particles/mm³.

3. As the method described in embodiment 1, wherein the volume of the liquid is less than or equal to 10 μL.

4. As the method described in embodiment 3, wherein the better volume of the liquid is ranging from 0.1 μL to 1 μL.

5. As the method described in embodiment 1, further comprises the steps of: converting the displacement to a radius of an image intensity correlation peak; and calculating the liquid viscosity from the radius.

6. As the method described in embodiments 1˜5, wherein the particle is a neutrally buoyant particle.

7. A method for measuring viscosity of a liquid comprises the steps of: preparing a liquid having a particle; recording a displacement generated from a Brownian motion caused by the particle in the liquid within a unit time; and measuring the liquid viscosity from the displacement.

8. As the method described in embodiment 7, wherein the particle is a neutrally buoyant particle.

9. As the method described in embodiment 7, wherein the volume of the liquid is less than or equal to 10 μL.

10. As the method described in embodiment 9, wherein the better volume of the liquid is ranging from 0.1 μL to 1 μL.

11. As the method described in embodiment 7, wherein the displacement is obtained by a particle displacement detecting method, and the method of detecting the particle displacement has no effect on the Brownian motion.

12. A device for measuring viscosity of a liquid comprises: a loading unit for loading a liquid having a particle; and a measuring unit for measuring a displacement generated from a Brownian motion caused by the particle in the liquid within a unit time, and measuring the liquid viscosity from the displacement.

To sum up, the present invention allows users to measure viscosity in a simple, inexpensive, and non-wasteful method and can be applied to use in various fields, such as biomedicine, mechanical engineering, chemical engineering, electro-optical engineering, semiconductor, petrochemical industry and so on. For instance, a specific viscosity of an expensive biological paste for carrying drug to treat intracranial aneurysms requires careful preparation before use. Moreover, the sample volume measured by the present invention only requires 0.1 μL instead of at least 10 μL by the other commercial viscometer.

Furthermore, by using three different glycerol solutions for test and correction, the results (viscosities) derived from the present invention are similar to the actual viscosities, which verify the practicality of the present invention.

According to the above description, in comparison with the traditional technique, a method and device for measuring liquid viscosity has the advantages as following: (1) micro-volume requirement, (2) broad-range measurability, (3) low cost, and (4) noninvasiveness.

What is claimed is:

1. A method for calculating viscosity of a liquid comprises the steps of:
preparing a liquid;
adding a particle into the liquid in which the particle generates a Brownian motion;
capturing a plurality of particle images within a unit time;
obtaining a displacement from the particle images; and
calculating viscosity of the liquid from the displacement.

2. As the method claimed in claim 1, wherein the particle at least has a diameter ranging from 0.05 μm to 1 μm, or is suspended in a fluid concentration ranging from 4×10⁷ particles/mm³ to 4×10⁹ particles/mm³.

3. As the method claimed in claim 1, wherein the volume of the liquid is less than or equal to 10 μL.

4. As the method claimed in claim 3, wherein the volume of the liquid ranges from 0.1 μL to 1 μL.

5. As the method claimed in claim 1, further comprises the steps of:
converting the displacement to a radius of an image intensity correlation peak; and
calculating the liquid viscosity from the radius.

6. As the method claimed in claim 1, wherein the particle is a neutrally buoyant particle.

7. As the method claimed in claim 2, wherein the particle is a neutrally buoyant particle.

8. As the method claimed in claim 3, wherein the particle is a neutrally buoyant particle.

9. As the method claimed in claim 4, wherein the particle is a neutrally buoyant particle.

10. As the method claimed in claim 5, wherein the particle is a neutrally buoyant particle.

11. A method for measuring viscosity of a liquid comprises the steps of:
preparing a liquid having a particle;
recording a displacement generated from a Brownian motion caused by the particle in the liquid within a unit time; and
measuring the liquid viscosity from the displacement.

12. As the method claimed in claim 11, wherein the particle is a neutrally buoyant particle.

13. As the method claimed in claim 11, wherein the volume of the liquid is less than or equal to 10 μL.

14. As the method claimed in claim 13, wherein the volume of the liquid ranges from 0.1 μL to 1 μL.

15. As the method claimed in claim 11, wherein the displacement is obtained by a particle displacement detecting method.

16. A device for measuring viscosity of a liquid comprises:
a loading unit for loading a liquid having a particle; and
a measuring unit for measuring a displacement generated from a Brownian motion caused by the particle in the liquid within a unit time, and measuring the liquid viscosity from the displacement.
